(19) United States
(12) Patent Application Publication
(10) Pub. No.: US 2017/0205503 A1
(43) Pub. Date: Jul. 20, 2017

(54) METHOD AND APPARATUS FOR DETECTING A SPEED AND A DISTANCE OF AT LEAST ONE OBJECT WITH RESPECT TO A RECEIVER OF A RECEPTION SIGNAL

(71) Applicant: JENOPTIK Robot GmbH, Monheim (DE)

(72) Inventors: Michael LEHNING, Hildesheim (DE); Dima PROEFROCK, Hildesheim (DE)

(73) Assignee: JENOPTIK Robot GmbH, Monheim (DE)

(21) Appl. No.: 15/329,592

(22) PCT Filed: Jul. 27, 2015
(86) PCT No.: PCT/EP2015/001542

§ 371 Date: Jan. 27, 2017

(30) Foreign Application Priority Data
Jul. 29, 2014 (DE) 10 2014 010 990.9

(51) Int. Cl. G01S 13/58; G01S 13/93; G01S 7/35

(52) U.S. Cl. CPC G01S 13/584; G01S 7/352; G01S 13/931; G01S 2007/358

(57) ABSTRACT

An apparatus for detecting a speed and a distance of at least one object with respect to a receiver of a reception signal. The apparatus has at least one interface for reading in at least one in-phase component and one quadrature component of a plurality of temporally successive reception signals each representing a signal which is reflected to the receiver at the object and was emitted at a predefined transmission frequency. The apparatus also has a unit for forming a first detection value and a unit for determining a second detection value and a unit for determining a speed, corresponding to a reference speed, of the object with respect to the receiver and the reference distance as the distance of the object with respect to the receiver using the first and second detection values.

This nonprovisional application is a National Stage of International Application No. PCT/EP2015/001542, which was filed on Jul. 27, 2015, and which claims priority to German Patent Application No. 10 2014 010 990.9, which was filed in Germany on Jul. 29, 2014, and which are both herein incorporated by reference.

### BACKGROUND OF THE INVENTION

Field of the Invention

The present invention relates to a method and an apparatus for detecting a speed and a range of at least one object in relation to a receiver of a received signal and to a corresponding computer program product.

Description of the Background Art

Resolution of the range of multiple objects (vehicles) moving at the same radial speed in relation to the radar is a demanding task within radar signal processing. In principle, this problem can be solved by radar systems operating over an extremely large bandwidth. On account of the restrictions of today's radar systems to bandwidths in the region of 250 MHz (K band), the use of a radar operating over a very wide range (e.g. UWB radar=Ultra Wide Band Radar) is not possible.

The actuation systems used at present for radar systems are restricted to what is known as Frequency Shift Keying (FSK method) or the FMCW method (FMCW=Frequency Modulated Continuous Wave). In the case of FSK methods, object separation is realized on the basis of the radial speed (subsequently speed). Later, the range per object can be measured. In the case of FMCW methods, object separation is normally realized on the basis of a combination of speed and object range. In a second step, both variables are computed in a concrete manner per object. Both methods can be implemented very simply in terms of hardware, but have only limited suitability for the resolution of multiple targets at the same speed.

Both FSK and FMCW methods are unable, or able only using very large bandwidths, to resolve multiple objects at the same relative speed.

In this connection, the prior art reveals the document EP 1873551 A1, which discloses a radar system in the automotive sector and a corresponding technique

### SUMMARY OF THE INVENTION

Against this background, the present invention presents a method for detecting a speed and a range of at least one object in relation to a receiver of a received signal, an apparatus for detecting a speed and a range of at least one object in relation to a receiver of a received signal and a corresponding computer program product according to the main claims. Advantageous configurations are obtained from the respective subclaims and the description below.

The approach presented here is used a method for detecting a speed and a range of at least one object in relation to a receiver of a received signal, wherein the method has at least the following steps:

reading in at least one inphase component and one quadrature component of a plurality of temporally successive received signals that each represent a signal reflected from on the object to the receiver, which signal was transmitted at a predefined transmission frequency;

forming a first detection value using the inphase component and the quadrature component of a first of the received signals, wherein the first detection value corresponds to a predetermined reference speed and a predetermined reference range of the object from the receiver;

ascertaining a second detection value using the inphase component and the quadrature component of a second of the received signals, wherein the second detection value corresponds to the predetermined reference speed and the predetermined reference range of the object from the receiver; and

determining a speed, corresponding to the reference speed, of the object in relation to the receiver and the reference range as the range of the object in relation to the receiver using the first and second detection values.

An object can be understood, by way of example, to mean a vehicle that travels in road traffic. A received signal may be, by way of example, a radar signal that is captured by an antenna as a receiver. A signal can be understood, in the present case, to mean a transmission signal that has been transmitted at a predefined transmission frequency and that is reflected from the object, so that the reflected signal forms the received signal. In this case, multiple signals can be transmitted, by way of example, at staggered times and at different transmission frequencies, so that the plurality of received signals, which is based on in each case one of the transmitted signals, are based on different transmission frequencies and are received at staggered times. A detection value can be understood to mean a value that is formed by transformation of the two components of the respective received signals. In this case, each detection value can be allocated a reference speed that, by way of example, represents a component of the reference speed in the relevant received signal. At the same time, each detection value has an associated reference range. The speed of the object and/or the range of the object in relation to the receiver can in this case be provided, by way of example, on the basis of a comparison of the detection value with another detection value or a reference value. It is also conceivable for the detection value to be processed further by further mathematical operations in order to ascertain the speed and/or the range of the object in relation to the receiver.

The approach presented here is based on the insight that this precise and accurate ascertainment of the speed and the range of the object relative to the receiver can take place when an inphase component and a quadrature component of a received signal are used that are each based on a (transmission) signal at a predetermined transmission frequency. In this case, it is first of all possible to ascertain from the two components of the received signal a detection value that is subsequently processed further for the purpose of analyzing different ranges of the object from the receiver. By taking into consideration multiple reference speeds and reference ranges, it is simultaneously possible to ascertain the probability of the object actually being at the relevant reference speed and reference range relative to the receiver. Therefore, an analysis is performed regarding how probably the object is at a relevant reference speed and/or a relevant reference range relative to the receiver.

In this case, the approach presented here affords the advantage that, in comparison with conventional approaches, technically relatively simple and numerically low-complexity means allow a marked improvement in the prediction of the actual speed and the actual range of the object relative to the receiver. At the same time, the approach presented provides a very good basis for precisely determining the speeds and ranges of multiple objects relative to the receiver. Additionally, there is also a simple expansion option of operating the approach presented here with multiple receivers in order to determine a further precision of the speed or range of an object relative to a receiver or multiple objects.

According to one embodiment of the approach presented here, the step of determining can involve the first and second detection values being added. The embodiment of the approach presented here affords the advantage of a particularly simple combination of the plurality of range values in order to use, by way of example, the detection value as a coefficient for a determined probability of the object being at a speed that corresponds to the speed value.

It is beneficial if, in accordance with an embodiment of the approach presented here, the step of forming further involves a third detection value being formed using the inphase component and the quadrature component of the first of the received signals. In this case, the third detection value corresponds to a further reference speed and to a further reference range of the object from the receiver. In this case, the step of ascertaining can further involve a fourth detection value being ascertained using the inphase component and the quadrature component of the second of the received signals, wherein the fourth detection value corresponds to the further reference speed and the further reference range of the object from the receiver. It is also possible for the step of determining a speed, corresponding to the reference speed, of the object in relation to the receiver and to the reference range as the range of the object in relation to the receiver to involve being determined using the third and fourth detection values. In this way, it is a very simple matter to ascertain that speed that, by way of example, is the greatest probability of being the actual speed of the object. As a result, it is possible to make a very precisely accurate prediction of the speed of the object. A similar situation also applies to the prediction of the range of the object from the receiver.

There is an advantage in an embodiment of the approach presented here in which the step of determining involves the reference speed as the speed of the object and the reference range as the range of the object in relation to the receiver being determined when a combined value comprising the first and second detection values is in a predetermined relationship with a combined value comprising the third and fourth detection values. As a result, it is a technically simple matter to implement precise detection of the speed and the range of the object.

It is particularly advantageous if an embodiment of the approach presented here has a step of transmitting the signal to be reflected from the object, wherein a transmission frequency of the signal is chosen on the basis of a pseudorandom sequence. Such an embodiment of the approach presented here affords the advantage that the received signals used for the presented approach is based on (transmission) signals that have a changing transmission frequency. As a result, the advantages of precise evaluation of a speed or a range of the object on the basis of different frequencies of the received signals can be used, the available frequency spectrum nevertheless not being blocked completely by the measurement of the speed and the range of the object or by the objects. As a result, it is further possible to likewise reduce or even largely avoid interference from adjacent measuring installations.

There is, further, particular efficiency in an embodiment of the approach presented here in which the step of reading in involves at least one inphase component and one quadrature component of a plurality of temporally successive antenna signals being read in, that each represent a signal reflected from on a further object to the receiver, which signal was transmitted at a predefined transmission frequency. In this case, the step of forming can involve a first identification value being formed using the inphase component and the quadrature component of a first of the antenna signals, wherein the first identification value corresponds to a predetermined further reference speed and to a predetermined further reference range of the further object from the receiver. It is also possible for the step of ascertaining to involve a second identification value being ascertained using the inphase component and the quadrature component of a second of the antenna signals, wherein the second identification value corresponds to the predetermined further reference speed and the predetermined further reference range of the further object from the receiver. Further, the step of determining can involve a speed, corresponding to the further reference speed, of the object in relation to the receiver and to a range, corresponding to the further reference range, of the further object in relation to the receiver being determined using the first and second identification values. In this way, it is advantageously possible for the determination of the range and the speed of multiple objects to be determined using an algorithm, this determining being linked to low additional complexity, and additionally being able to take place very precisely and accurately.

In order to allow particularly accurate determination of a speed and range of the at least one object, multiple receivers can each read in and process a receiver signal or object signal. In particular, in this case, it is possible for the step of reading in to involve at least one inphase component and one quadrature component of a plurality of temporally successive object signals that each represent a signal reflected from on the object to a further receiver, which signal was transmitted at a different transmission frequency. Further, the step of forming can involve a first object detection value being formed using the inphase component and the quadrature component of the first of the object signals, wherein the first object detection value corresponds to the reference speed and the reference range of the object from the further receiver. It is also possible for the step of ascertaining to involve the second object detection value being formed using the inphase component and the quadrature component of a second of the object signals, wherein the second object detection value corresponds to the reference speed and to the reference range of the object from the further receiver. Further, the step of determining can involve a speed, corresponding to the reference speed, of the object in relation to the further receiver and to the reference range as the range of the object in relation to the further receiver being determined using the first and second object detection values.

Such an embodiment of the approach presented here can therefore be used to process and evaluate data from multiple receivers, so that an increase in accuracy for the determination of the speed and the range of the object for a further object becomes possible. In this case, merely little additional complexity is required, since the algorithms presented here are expandable in a simple manner for processing signals from multiple receivers.

Additionally, in a further embodiment of the approach presented here, there may be provision for a step of detecting an angle between the object, the receiver and the further receiver. In this case, the step of detecting can involve the angle being provided using a distance between the receiver and the further receiver and/or an averaged frequency from those transmission frequencies that correspond to received signals that are the basis for the determination of the detection value and the further detection value. Such an embodiment of the approach presented here affords the advantage of not being able to ascertain a speed and range of multiple objects in relation to the receiver and/or the further receiver, but also being able to determine a physical arrangement of the objects relative to one another, which is represented by an angle of the objects in relation to the receiver and/or the further receiver.

There is further benefit in an embodiment of the approach presented here as an apparatus for detecting a speed and a range of at least one object in relation to a receiver of a received signal, wherein the apparatus has at least the following features:

an interface for reading in at least one inphase component and one quadrature component of a plurality of temporally successive received signals that each represent a signal reflected from on the object to the receiver, which signal was transmitted at a predefined transmission frequency;

a unit for forming a first detection value using the inphase component and the quadrature component of a first of the received signals, wherein the first detection value corresponds to a predetermined reference speed and a predetermined reference range of the object from the receiver;

a unit for ascertaining a second detection value using the inphase component and the quadrature component of a second of the received signals, wherein the second detection value corresponds to the predetermined reference speed and the predetermined reference range of the object from the receiver; and

a unit for determining a speed, corresponding to the reference speed, of the object in relation to the receiver and the reference range as the range of the object in relation to the receiver using the first and second detection values.

The apparatus is therefore designed to perform or implement the steps of a variant of a method presented here in appropriate devices. This variant embodiment of the invention in the form of an apparatus can also quickly and efficiently achieve the object on which the invention is based.

An apparatus can, in the present instance, be understood to mean an electrical appliance that processes sensor signals and takes this as a basis for outputting control and/or data signals. The apparatus can have an interface that may be in hardware and/or software form. In the case of a hardware form, the interfaces may be, for example, part of what is known as a system ASIC that includes a wide variety of functions of the apparatus. However, it is also possible for the interfaces to be dedicated integrated circuits or to consist at least in part of discrete components. In the case of a software form, the interfaces may be software modules that are present, by way of example, on a microcontroller besides other software modules.

There is also advantage in a computer program product having program code that can be stored on a machine-readable medium such as a semiconductor memory, a hard disk memory or an optical memory and is used for performing the method according to one of the embodiments described above when the program product is executed on a computer or an apparatus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a traffic monitoring system having an apparatus according to an exemplary embodiment of the present invention;

FIG. 2 shows a block diagram of an apparatus for detecting a speed and a range of at least one object in relation to a receiver of a received signal according to an exemplary embodiment of the present invention;

FIG. 3 shows a 2D representation of absolute values on a map Mₜᵥ from which a speed and a range of at least one object in relation to a receiver of a received signal is detectable; and

FIG. 4 shows a flowchart of a method according to an exemplary embodiment of the present invention.

### DETAILED DESCRIPTION

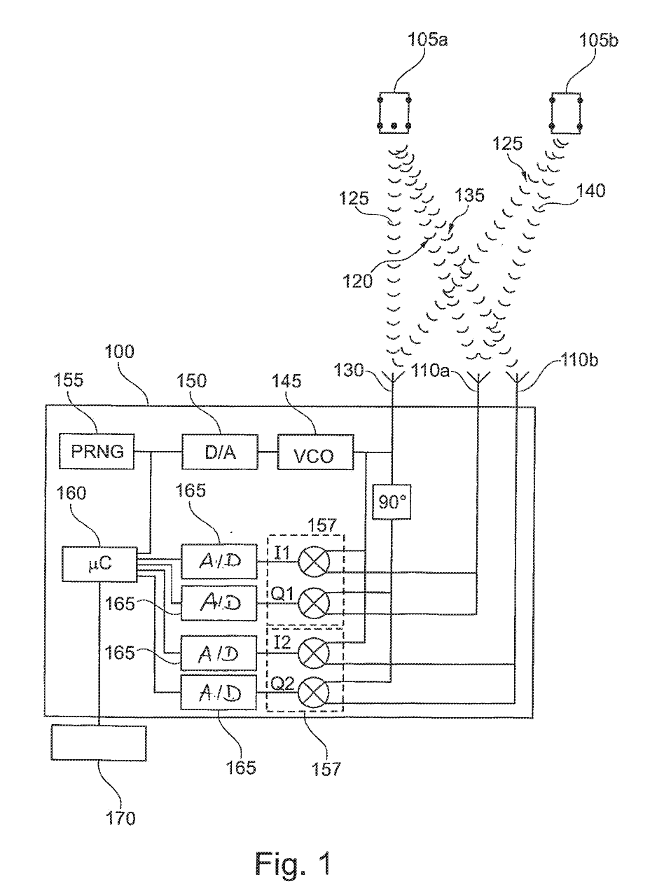

FIG. 1 shows a block diagram of an exemplary embodiment of the present invention in the form of a traffic monitoring system 100 having an apparatus for detecting a speed and a range of at least one object 105a in relation to at least one receiver 110a (for example in the form of a radar reception unit) of a received signal 120. The object 105a may, like the further object 105b, be a vehicle that is exposed to a signal 125 from a radar transmission antenna 130 as transmitter. Similarly, a further receiver 110b (for example likewise in the form of a radar reception unit) can receive into a further received signal 135 that is emitted from the object 105 to the further receiver 110b on account of a reflection of the signal 125. Additionally, a further object 105b can be exposed to the signal 125, from which object the signal 125 is reflected and is sent as an additional received signal 140 to the receiver 110a.

In the exemplary embodiment presented in FIG. 1, the frequency generation for the signal 125 is designed such that what is known as a VCO 145 (Voltage Controlled Oscillator) is used whose frequency is placed in proportion to the actuating voltage. So as now to realize pseudorandom frequency control, a digital/analog converter 150 is actuated using a pseudorandom digital sequence from a pseudo noise generator 155 (PRNG) that is converted into a pseudorandom frequency sequence.

The approach presented here is based on pseudorandom actuation such that down conversion of the signal 120, 135 (also referred to as object signal) or 140 (also referred to as antenna signal) received by one at one of the receivers 110 entails the amplitude and the phase of the low frequency mixed signal being digitized. This normally involves what is known as an IQ mixer 157 for each path from one of the receivers 110 to a processing unit being used as an apparatus 160 for detecting a speed and a range of at least one object 105a, which IQ mixer is capable of digitizing the inphase (I1, I2) and quadrature (Q1, Q2) components, as depicted in FIG. 1 using an example of one transmission and two reception antennas or units. In this case, each of the IQ mixers 157 is provided with the signal provided by the VCO (which corresponds to the transmission signal along with amplitude and phase), a signal phase-shifted through 90° provided by the VCO and the received signal 120, 135 or 140 received by the receiver 110 respectively connected to the relevant IQ mixer 157. Each of the inphase outputs 11 and 12 and quadrature outputs Q1 and Q2 are connected via an ND converter 165 to the processing unit 160, in this case a microcontroller, in which the data delivered from the IQ mixers 157 are processed in accordance with the description below, for example. From this processing, it is then possible to determine the desired targets 170 that correspond to a range and speed of the objects 105a and 105b.

In the exemplary embodiment presented here, a concept is therefore proposed for how to use frequency actuation limited to a relatively narrow bandwidth to discover multiple targets simply and systematically. The method proposed here improves the options by virtue of the pseudorandom actuation of the frequency generation. There is therefore a technically simple and numerically simply implemented opportunity for multiple resolution of objects with regard to relative speed and range relative to the radar using a small bandwidth (250 MHz max.). In this case, it is also possible for objects at the same objective speed but a different range can to be resolved. In addition, the approach presented here can also be used to resolve objects at the same range but different relative speed.

The frequency selection of the existing radar systems (FST3/TR6000) is modified, by way of example, such that a pseudorandom frequency is produced per sampling time. A discrete speed/range transformation accumulates the sampled values into a speed/range space. The range and relative speed of multiple objects can be read off directly in the measurement space.

As is known for the FSK method, the frequency is kept stable for a short period, e.g. one hundred thousandth of a second, by virtue of appropriate action of the VCO 145, in order to measure phase and amplitude for said frequency. On the basis of this actuation, a number of amplitude and phase values—scattered over time—of the received signals 120, 135 and 140 are therefore obtained, for which, in each case, the transmission frequency of the signal 125 at which this value of the received signals 120, 135 and 140 was measured is known.

For each sampled value, the underlying transmission frequency f is therefore known. In addition, the time t at which this frequency f was generated by the VCO 145 is known. For each individual sample value (i.e. of a value of the IQ mixer 157 delivered by the A/D converter 165) for that one of the received signals 120, 135 and 140 to be evaluated as appropriate, the following transformation is now performed:

The speed is quantized into Nᵥ fine stages (which are subsequently referred to as reference speeds), e.g. from 0 to 100 m/s in 0.2 m/s steps. For each quantization point (that is to say for each reference speed), the measured phase and amplitude of the received signal 120, 125, 135 or 140 currently read in is modulated such that it corresponds to a time t₀ at the corresponding (reference) speed. For a sample x of the frequency f at the time t, the modulated value xᵥ is obtained as follows:

$${x}_{v} = x \cdot {e}^{i \cdot 4 \cdot π \cdot v \cdot ( t - {t}_{0} ) \cdot \frac{f}{{c}_{0}}}$$

where c₀=speed of light and v=(reference) speed. A modulated value of such kind that is ascertained on the basis of the different reference speeds is subsequently referred to as a speed value. The time t₀ can be chosen arbitrarily. At the end of this transformation, by way of example, for all Nₜ sampled values (e.g. 1024 delivered values from the A/D converters 165) are therefore associated with all potential (reference) speeds, so that the (speed) values are accommodated in a matrix Aₜᵥ of magnitude Nₜ×Nᵥ.

The range is quantized into Nᵣ fine stages (subsequently also referred to as reference ranges), e.g. from 0 to 200 m in 0.25 m steps. For each point of the matrix Aₜᵥ, the phase and the amplitude are modulated such that they correspond to the respective range of the fine stages and reference ranges. For a value xᵥ (i.e. for each speed value) of the frequency f, the modulated value xᵥᵣ, is obtained as follows:

$${x}_{vr} = {x}_{v} \cdot {e}^{i \cdot 4 \cdot π \cdot r \cdot \frac{f}{{c}_{0}}}$$

where r =range. This modulated value is referred to as a range value in the description below. That is to say that each point of the matrix Aₜᵥ is augmented by a vector of length Nᵣ. The volume Vₜᵥᵣ, with the dimensions samples, speed and range is obtained.

Each point in the volume Vₜᵥᵣ now corresponds to a hypothesis for a sample of one of the received signals 120, 125, 135 and 140 on the basis of an assumed speed (reference speed) and an assumed range (reference range).

Following the transformation, the multiple target resolution can be achieved as follows.

If a ray is placed through the volume Vₜᵥᵣ along the dimension of the samples and the complex values of the volume along this ray are summed, then, for a determined speed/range hypothesis, a complex value is obtained whose absolute value is a measure of the probability of occurrence of an object 105a or 105b. In practice, the volume along the dimension of the samples can be summed. A 2D map Mₜᵥ is obtained regarding probabilities of occurrence of objects at a particular speed and a particular range.

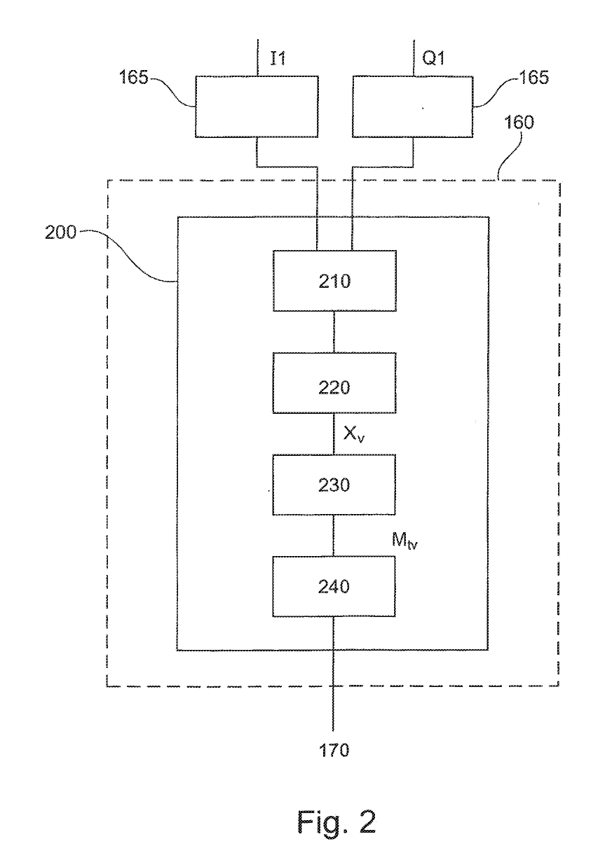

FIG. 2 shows a block diagram of an exemplary embodiment of an apparatus 200 for detecting a speed and a range of at least one object in relation to a receiver of a received signal. This apparatus 200 may, for example, be part of the processing unit 160 from FIG. 1, which is depicted as a microcontroller. In FIG. 2, the apparatus 200 is depicted merely connected to a reception unit 110a.

The apparatus 200 comprises at least one interface 210 for reading in at least one inphase component 11 and one quadrature component Q1 of a plurality of temporally successive received signals 120 that each represent a signal 125 that is reflected from on the object 105a to the receiver 110a and that was transmitted at a predefined transmission frequency f. Further, the apparatus 160 comprises a unit 220 for forming a first detection value xᵥᵣ using the inphase component I1 and the quadrature component Q1 of a first of the received signals 120, wherein the first detection value xᵥᵣ corresponds to a predetermined reference speed v and a predetermined reference range r of the object 105a from the receiver 110a. The apparatus 160 also comprises a unit 230 for ascertaining a second detection value xᵥᵣ using the inphase component I1 and the quadrature component Q1 of a second of the received signals 120, wherein the second detection value xᵥᵣ corresponds to the predetermined reference speed v and the predetermined reference range r of the object 105a from the receiver 110a. Finally, the apparatus 160 comprises a unit for determining 440 a speed v, corresponding to the reference speed v, of the object 105a in relation to the receiver 110a and the reference range v as the range of the object 105a in relation to the receiver 110a using the first and second detection values xᵥᵣ.

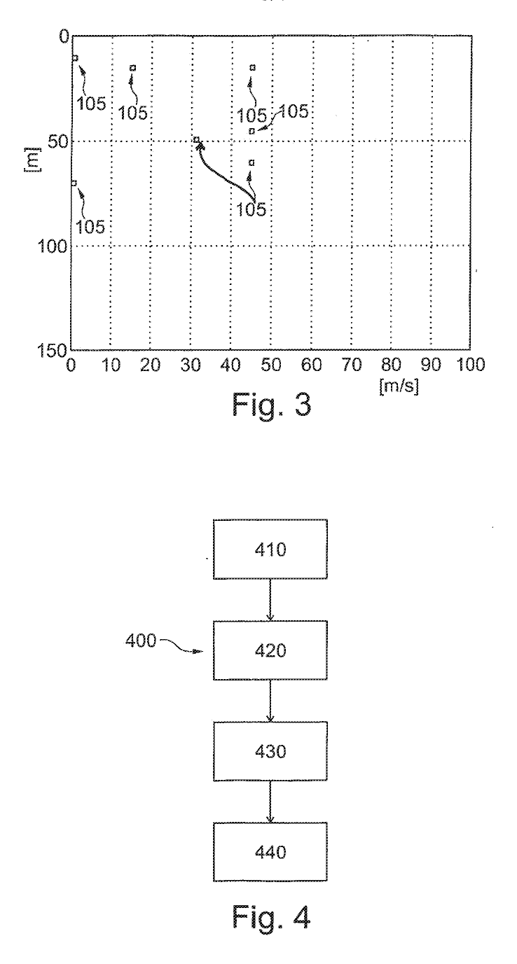

FIG. 3 shows a 2D depiction of absolute values on a map Mₜᵥ in which seven objects 105 are discernible as light points at speeds of 0, 15, 30 and 45 m/s and ranges of 20 m, 50 m, 60 m and 75 m. In this case, instead of the two objects 105a and 105b depicted in FIG. 1, seven objects 105 have been sensed, the respective ranges and speeds of the objects 105 relative to the receiver 110a having been entered in the map from FIG. 2.

If more than one reception antenna or reception unit 110a is used (as portrayed in FIG. 1 by the depicted further reception unit 110b), then a corresponding map Mₜᵥⁱ can be determined for each reception antenna or reception unit i, for example in accordance with the procedure described above, using a received signal 135 or 140 from this reception unit i. From the phase difference Δφ=φ(Mₜᵥ¹(t, v))−φ(Mₜᵥ²(t, v)) for a measurement points t,v in two maps Mₜᵥ¹ and Mₜᵥ², it is possible, for example, to measure the angle at which the object is situated

$$α = arcsin ( \frac{Δ ϕ \cdot λ}{2 \cdot π \cdot d} ) ,$$

where λ is the average wavelength of the frequencies used and d is the distance between the reception antennas under consideration. Alternatively, the 3D samples/speed/range space can also be expanded by the fourth dimension “angle”. In this case, an appropriate modulation of the amplitudes and phases is performed on the basis of an angle quantized into fine stages (which can also be referred to as reference angles) (e.g. −18° to 18° in 0.01° steps). A summation using the “samples” dimension delivers a speed/range angle space. This approach allows objects to be separated with regard to their speed, their range and their angle.

FIG. 4 shows a flowchart of an exemplary embodiment of the approach presented here as a method 400 for detecting a speed and a range of at least one object in relation to a receiver of a received signal. The method 400 comprises a step 410 of reading in at least one inphase component and on quadrature component of a plurality of temporally successive received signals that each represent a signal that is reflected from on the object to the receiver and that was transmitted at a predefined transmission frequency. Further, the method 400 comprises a step of forming 420 a first detection value xᵥᵣ using the inphase component of the quadrature component of a first of the received signals, wherein the first detection value corresponds to a predetermined reference speed and a predetermined reference range of the object from the receiver. The method 400 also comprises a step of ascertaining 430 a second detection value using the inphase component and the quadrature component of a second of the received signals, wherein the second detection value corresponds to the predetermined reference speed and the predetermined reference range of the object from the receiver. Finally, the method 400 comprises a step of determining 440 a speed, corresponding to the reference speed, of the object in relation to the receiver and the reference range as the range of the object in relation to the receiver using the first and second detection values.

The approach presented here affords some advantages over the known approaches according to the prior art. In this context, it is firstly possible to cite the option of being able to perform a resolution for multiple objects both at the same range and at the same relative speed, current approaches being able to resolve only on the basis of relative speed. In addition, it is also possible for stationary objects to be measured, and for multiple operation of radars to be effected in the same frequency band on the basis of the pseudorandom modulation of the transmission signals of the signal transmitted by an apparatus in accordance with an exemplary embodiment described here. Also, stochastic sampling through pseudorandom modulation means that no systematic errors as a result of overlaps can arise (e.g. roaming of unprocessed targets, cancelations, etc.). Finally, the approach presented here makes it possible to prevent overreaches by the transmission signals used from causing interference in other apparatuses that are likewise provided for detecting a speed and range of an object.

In summary, it can therefore be noted that the approach presented here, in contrast to methods existing hitherto, allows very good resolution of speed and range to be achieved both for vehicles that start at the same range and travel at different speeds and for objects that travel at the same speed but at different ranges. In addition, if necessary and if at least two reception antennas or reception units are present, it is also possible for separation to be effected on the basis of object angle. Therefore, objects that exist in the measurement area at the same speed and the same range can also be resolved. The approach presented here is therefore superior to conventional methods of modulation technology as have been used hitherto. Conventional FSK and FMCW modulation techniques use deterministic frequency profiles, which is why simultaneous use of multiple radars results either in mutual interference or in reduction of the bandwidth. The use, proposed by way of example, of a pseudorandom frequency within the chosen frequency band allows many radars to be operated in parallel at the same time without significantly interfering with one another. In this case, a variable seed value of the random number generator can minimize the probability of the same frequencies arising for different radars at the same time. A further great advantage of the use of pseudorandom frequencies is the elimination of systematic measurement errors, which can arise as a result of aliasing and interference effects and can significantly interfere with radar measurements, which is known as stochastic sampling.

The approach presented here can also be used for measurements outside road safety. In particular, the method also allows improved spatial resolution when surveying general 3-dimensional objects.

The exemplary embodiments described and shown in the figures are chosen merely by way of example. Different exemplary embodiments can be combined with one another fully or in respect of individual features. It is also possible for one exemplary embodiment to be augmented by features from a further exemplary embodiment.

Further, method steps according to the invention can be performed repeatedly and in an order other than the one described.

Where an exemplary embodiment comprises an “and/or” conjunction between a first feature and a second feature, this is intended to be read to mean that the exemplary embodiment has both the first feature and the second feature in accordance with one embodiment and either just the first feature or just the second feature in accordance with a further embodiment.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for detecting a speed and a range of at least one object in relation to a receiver of a received signal, the method comprising:
reading in at least one inphase component and one quadrature component of a plurality of temporally successive received signals that each represent a signal reflected from on the object to the receiver, which signal was transmitted at a predefined transmission frequency;
forming a first detection value using the inphase component and the quadrature component of a first of the received signals, wherein the first detection value corresponds to a predetermined reference speed and a predetermined reference range of the object from the receiver;
ascertaining a second detection value using the inphase component and the quadrature component of a second of the received signals, wherein the second detection value corresponds to the predetermined reference speed and the predetermined reference range of the object from the receiver; and
determining a speed, corresponding to the reference speed, of the object in relation to the receiver and the reference range as the range of the object in relation to the receiver using the first and second detection values.

2. The method as claimed in claim 1, wherein the step of determining involves the first and second detection values being added.

3. The method as claimed in claim 1, wherein the step of forming further involves a third detection value being formed using the inphase component and the quadrature component of the first of the received signals, wherein the third detection value corresponds to a further reference speed and to a further reference range of the object from the receiver,
wherein the step of ascertaining further involves a fourth detection value being ascertained using the inphase component and the quadrature component of the second of the received signals, wherein the fourth detection value corresponds to the further reference speed and the further reference range of the object from the receiver, and
wherein the step of determining a speed, corresponding to the reference speed, of the object in relation to the receiver and to the reference range as the range of the object in relation to the receiver involves being determined using the third and fourth detection values.

4. The method as claimed in claim 3, wherein the step of determining involves the reference speed as the speed of the object and the reference range as the range of the object in relation to the receiver being determined when a combined value comprising the first and second detection values is in a predetermined relationship with a combined value comprising the third and fourth detection values.

5. The method as claimed in claim 1, wherein a step of transmitting the signal to be reflected from the object, wherein a transmission frequency of the signal is chosen on the basis of a pseudorandom sequence.

6. The method as claimed in claim 1, wherein the step of reading in involves at least one inphase component and one quadrature component of a plurality of temporally successive antenna signals being read in, that each represent a signal reflected from on a further object to the receiver, which signal was transmitted at a predefined transmission frequency,
wherein the step of forming involves a first identification value being formed using the inphase component and the quadrature component of a first of the antenna signals, wherein the first identification value corresponds to a predetermined further reference speed and to a predetermined further reference range of the further object from the receiver;
wherein the step of ascertaining involves a second identification value being ascertained using the inphase component and the quadrature component of a second of the antenna signals, wherein the second identification value corresponds to the predetermined further reference speed and the predetermined further reference range of the further object from the receiver, and
wherein the step of determining involves a speed, corresponding to the further reference speed, of the object in relation to the receiver and to a range, corresponding to the further reference range, of the further object in relation to the receiver being determined using the first and second identification values.

7. The method as claimed in claim 1, wherein the step of reading in involves at least one inphase component and one quadrature component of a plurality of temporally successive object signals that each represent a signal reflected from on the object to a further receiver, which signal was transmitted at a different transmission frequency,
wherein the step of forming involves a first object detection value being formed using the inphase component and the quadrature component of the first of the object signals, wherein the first object detection value corresponds to the reference speed and the reference range of the object from the further receiver,
wherein the step of ascertaining involves the second object detection value being formed using the inphase component and the quadrature component of a second of the object signals, wherein the second object detection value corresponds to the reference speed and to the reference range of the object from the further receiver, and
wherein the step of determining involves a speed, corresponding to the reference speed, of the object in relation to the further receiver and to the reference range as the range of the object in relation to the further receiver being determined using the first and second object detection values.

8. The method as claimed in claim 7, wherein a step of detecting an angle between the object, the receiver and the further receiver, wherein the step of detecting involves the angle being provided using a distance between the receiver and the further receiver and/or an averaged frequency from those transmission frequencies that correspond to received signals that were used to determine the first and second detection values and the first and second object detection values.

9. An apparatus for detecting a speed and a range of at least one object in relation to a receiver of a received signal, wherein the apparatus has at least the following features:
an interface for reading in at least one inphase component and one quadrature component of a plurality of temporally successive received signals that each represent a signal reflected from on the object to the receiver which signal was transmitted at a predefined transmission frequency;
a unit for forming a first detection value using the inphase component and the quadrature component of a first of the received signals, wherein the first detection value corresponds to a predetermined reference speed and a predetermined reference range of the object from the receiver;
a unit for ascertaining a second detection value using the inphase component and the quadrature component of a second of the received signals, wherein the second detection value corresponds to the predetermined reference speed and the predetermined reference range of the object from the receiver and
a unit for determining a speed, corresponding to the reference speed, of the object in relation to the receiver and the reference range as the range of the object in relation to the receiver using the first and second detection values.

10. A computer program product having program code for performing the method as claimed in claim 1, when the program product is executed on an apparatus.
